(19) United States
(12) Patent Application Publication
(10) Pub. No.: US 2017/0292597 A1
(43) Pub. Date: Oct. 12, 2017

(54) SYSTEM FOR ALTERNATIVE GEARING SOLUTIONS

(71) Applicant: Kugar Inc., San Francisco, CA (US)

(72) Inventor: Gary Stanley Kurek, San Francisco, CA (US)

(21) Appl. No.: 15/480,818

(22) Filed: Apr. 6, 2017

Related U.S. Application Data
(60) Provisional application No. 62/319,222, filed on Apr. 6, 2016.

(51) Int. Cl. F16H 49/00; H02K 49/10; F16H 57/08; F16H 55/12; F16H 1/34

(52) U.S. Cl. CPC F16H 49/001; F16H 55/12; F16H 1/34; F16H 57/08; H02K 49/102; F16H 2049/003; F16H 2055/176

(57) ABSTRACT

A configurable gear system that includes a set of gear segments; each gear segment of the set of gear segments including a base structure, a gearing surface connected to the base structure and extended along at least one face, and two segment connectors at opposing sides of the gearing surface; and wherein at least a subset of the gear segments interconnect through the gear connector interface into a gearing configuration.

### CROSS-REFERENCE TO RELATED APPLICATIONS

This Application claims the benefit of U.S. Provisional Application No. 62/319,222, filed on 6-Apr.-2016, which is incorporated in its entirety by this reference.

### TECHNICAL FIELD

This invention relates generally to the field of mechanical gears, and more specifically to a new and useful system for alternative gearing solutions.

### BACKGROUND

Motor drives, transmissions, and gears are critical parts of robotics, manufacturing, automation, and many other fields. Such components must be carefully selected based on the performance requirements of a part's intended use. In many cases, this may mean using a variety of parts possibly from different vendors to accommodate different performance targets. Even more problematic is that, in some cases, a part with a particular performance property may not be readily available and may need to be custom made.

In particular, strain wave gears are one critical type of mechanical gearing system. Strain wave gears include a wave generator, a flex spline, and circular spline. The strain wave gear can provide high torque density—offering high torque in a relatively compact space and low weight. The strain wave gear can achieve high gear reduction ratios of 30:1 to even 320:1 in a space where planetary gears may only provide 10:1. Strain wave gears are additionally cited as providing “zero backlash”. However, such claims do not reflect true lifetime properties of a strain wave gear. Wear between the teeth leads to eventual backlash. Additionally, strain wave gears are very expensive and complex to manufacture. Individual parts are often individually customized almost to a molecular level to pair with other parts for a single unit. Other forms of drives include cycloidal drives. Cycloidal drives are generally heavier and are not typically backdrivable. Thus, there is a need in the gearing field to create a new and useful customizable planetary frictional gear system. Thus, there is a need in the mechanical gear field to create a new and useful system for alternative gearing solutions. This invention provides such a new and useful systems.

### BRIEF DESCRIPTION OF THE FIGURES

FIG. 1 is a schematic representation of a modular system of a preferred embodiment;

FIGS. 2A-2C are exemplary implementations of a system of a preferred embodiment used in gearing configurations of different sizes;

FIGS. 3A-3G are schematic representations of exemplary implementations of gearing segments;

FIGS. 4A and 4B are schematic representations of flexible gearing segment strips;

FIGS. 5A-5C are detailed schematic representations of a segment connector of a gearing segment;

FIG. 6 is a schematic representation of an outer gear brace;

FIG. 7 is a schematic representation of a gear brace mounted on the side of a gearing configuration'

FIGS. 8A-8C are schematic representations of a gearing configuration with non-parallel gearing surfaces using different gear brace variations;

FIG. 9 is a schematic representation of a gearing configuration with external parallel gearing surface;

FIGS. 10A and 10B are schematic representations of non-parallel gearing segments used in a linear gear configuration;

FIG. 11 is an exemplary configuration of parallel gearing segments used for linear actuation along an arbitrary path;

FIG. 12 is a side profile of an inter-stack brace used in physically coupling two gearing configurations;

FIG. 13 is a schematic representation of multiple stacked gearing configurations;

FIG. 14 is a schematic representation of parallel gearing used in abasic parallel gearing configuration;

FIG. 15 is a detailed schematic representation of parallel gearing used in a linear configuration;

FIGS. 16A-16C are schematic representations of parallel gearing used in circular configuration;

FIGS. 17A and 17B are detailed schematics of exemplary implementations of parallel gearing for an annular ring;

FIGS. 18A and 18B are detailed schematic representations of longitudinal structures used in rigid and flexible segments;

FIGS. 19A-19C are side profile representations of exemplary longitudinal structure patterns;

FIGS. 20 and 21 are schematic representations of exemplary planetary frictional gear systems with pressure control systems;

FIG. 22 is a schematic representation of a planetary frictional gear system with a flexspline;

FIG. 23 is a representation of a planetary module path along the annular ring; and

FIG. 24 is a schematic representation of a flexspline between parallel gearing surfaces.

### DESCRIPTION OF THE EMBODIMENTS

The following description of the embodiments of the invention is not intended to limit the invention to these embodiments but rather to enable a person skilled in the art to make and use this invention.

### 1. A Modular Gearing System

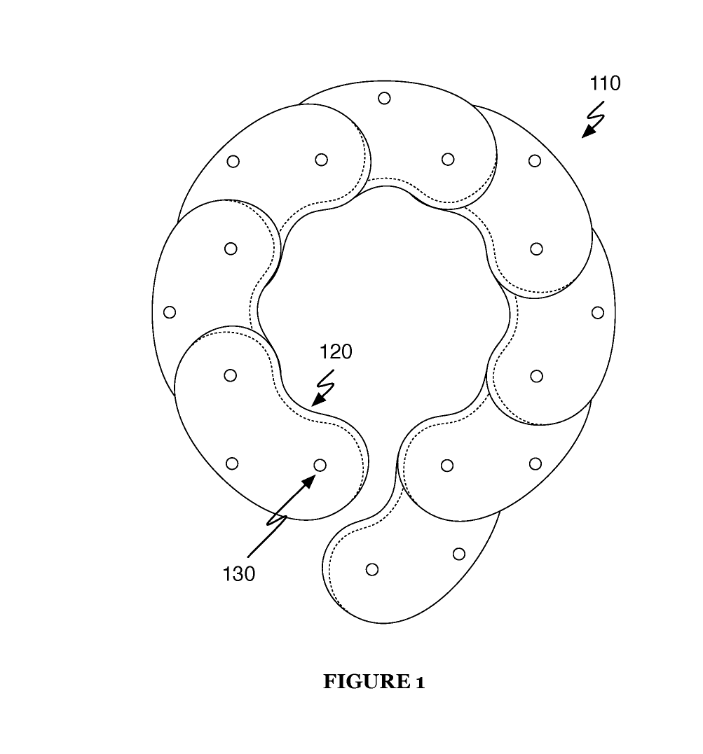

As shown in FIG. 1, a system for a modular and configurable gear system of a preferred embodiment can include a set of gearing segments 110 with a gearing surface 120 and that are interconnectable through one or more segment connectors 130. The system can additionally include an outer brace 140. The system can enable customizable gear configurations that may be used for gearing, transmissions, motor drives, linear guide rails, or other applications. The system can be used in assembling the system components into one or more different gearing configurations that can be interoperable with other gear components (e.g., either modular gear components using the system or traditionally manufactured gears). A gearing configuration preferably has a connected gearing surface, resulting from the connecting one segment connector 130 to another segment connector 130, that that can suitably engage with other gear components. The customizability of the system may be used in customizing properties such as gear size, gear path or shape, transmission ratios, and mechanical limits.

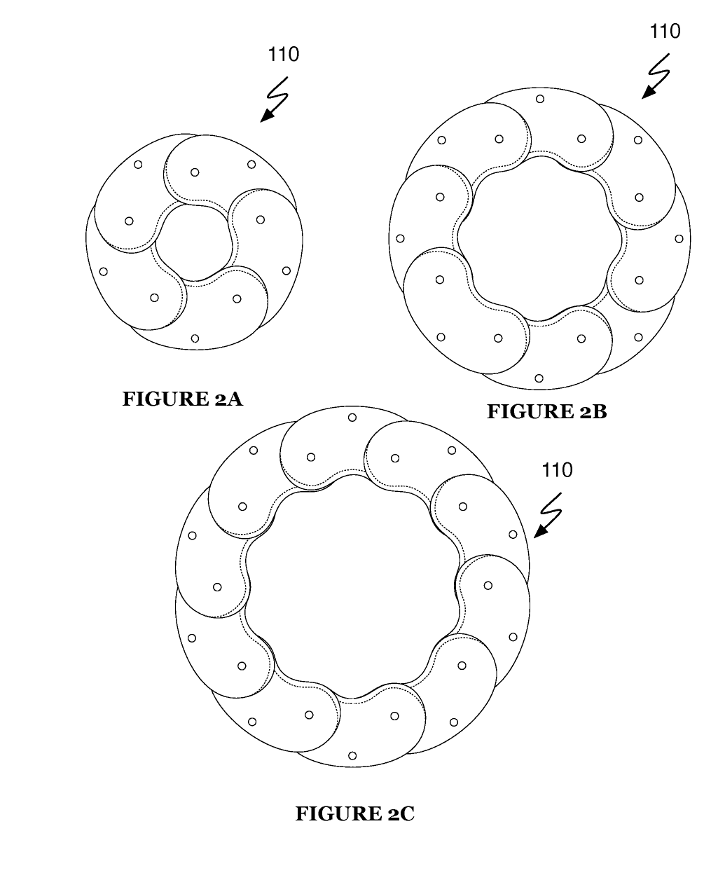

As an exemplary application, gearing segments no can be hinged components that can be interconnected into varying sizes of rings with a continuous gearing surface. The diameter of a resulting gearing configuration (i.e., an assembled gear system) could be increased by adding one or more gearing segments no, and the diameter could be reduced by removing one or more gearing segments 110 as shown in FIGS. 2A, 2B and 2C. The gearing segments 110 could additionally or alternatively be used in a smooth shape configuration (e.g., ellipse, irregular smoothed shape, etc.), a linear gearing configuration, and/or an arbitrary path configuration. An arbitrary path configuration preferably has a shape profile that approximates a continuous function between two terminating points. In being a modular system, a large variety of configurations can be provided through a limited set of components, which may be beneficial to improving cost of manufacturing and to reducing the number of unique parts kept in inventory.

The modular gearing system is preferably used with a physical gearing system that can include non-parallel / perpendicular gearing (e.g., using traditional gear teeth engagement structures) and/or parallel gearing.

Perpendicular gearing (i.e., non-parallel gearing) is characterized as having gear teeth or physical structures that are defined along a direction that is not parallel to the rotation or translation path of a transmission/assembly during engagement with another gear component. At least one portion of the direction vector of a perpendicular gear tooth is perpendicular to the direction or rotation or translation. As another characteristic, perpendicular gearing includes gear teeth that are non-continuous. Perpendicular gearing includes gearing surfaces that include gear teeth with structure similar to a spur or straight-cut gear, a helical gear, a hypoid gear, a bevel gear, or any suitable type of gear tooth that extends across the width of the gearing surface.

Parallel gearing is characterized as having physical structure features (e.g., frictional contact surface, longitudinal grooves/teeth, perimeter grooves) that are defined along a direction that is parallel to the rotation path during engagement with another gear component. More specifically, the “teeth” of the gear are defined along a direction that is parallel to the tangent of the rotational arc of an engaged gear component. Another characteristic of parallel gearing can be gear teeth (or more specifically longitudinal structures or “grooves”) that are continuous along the length of a gearing system. A connected gearing surface with parallel gearing has gear teeth bridging between different gearing segments no. In other words the number of gearing segments does not alter the number of “gear teeth” in a parallel gearing variation. However, stacking and other alternatives may be employed to alter the number of “gear teeth”. The parallel gearing preferably operates at least partially through frictional surface interactions. Herein, such frictional contract surface features used for parallel gearing are generally referred to as longitudinal structures.

The modular gearing system could alternatively be used in magnetic gearing where inter-gear engagement occurs through magnetic field interactions or any suitable type of gearing.

### Gearing Segments

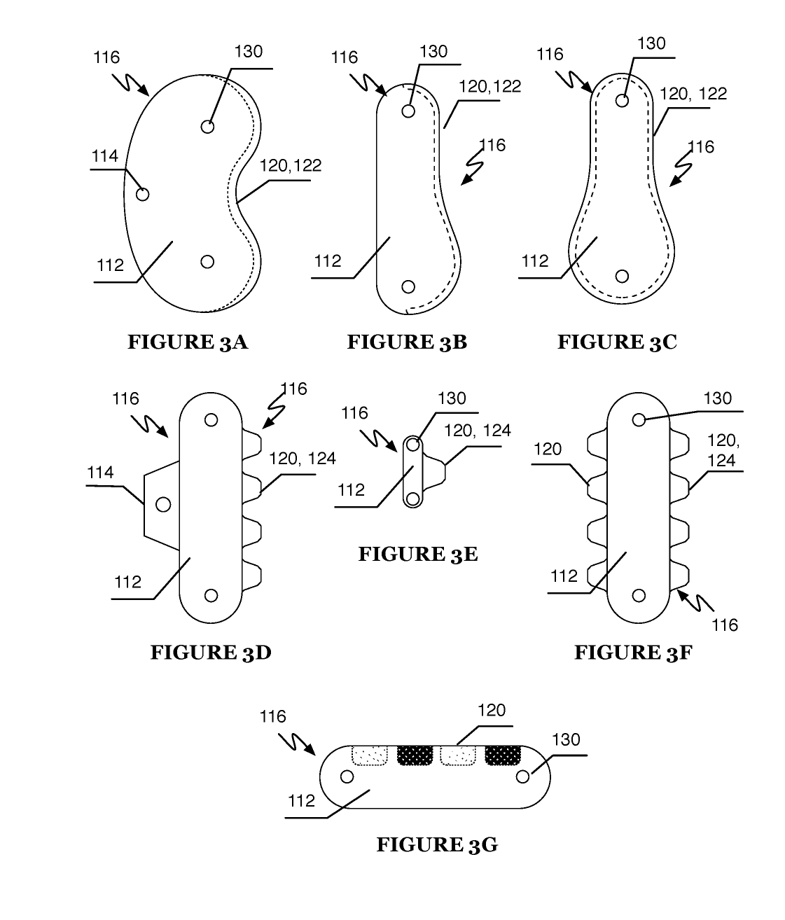

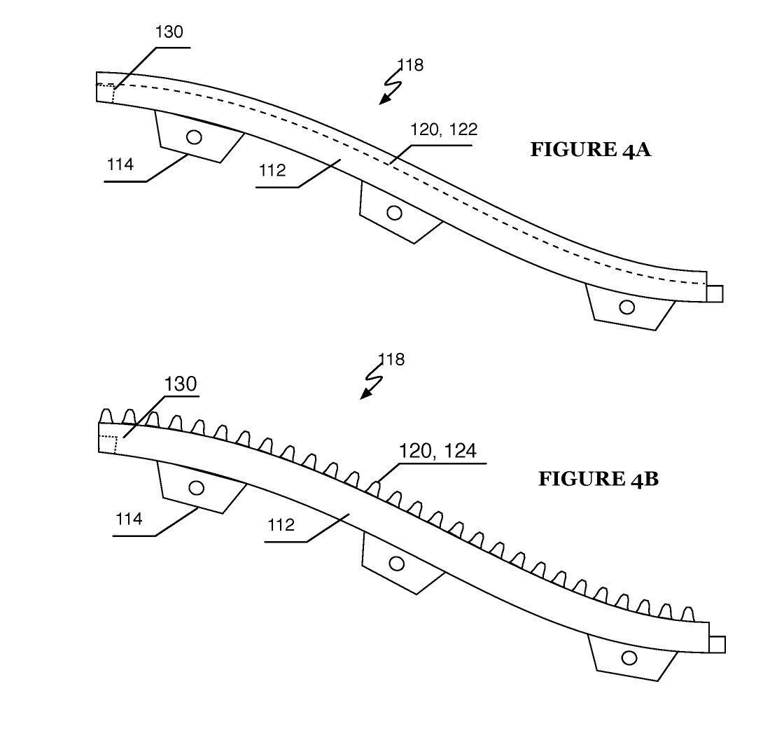

The set of gearing segments 110 function to be connectable components that can be interconnected into different gearing configurations. A gear segment 110 preferably includes a base structure 112 that connects a gearing surface 120 and preferably two segment connectors 130. A gearing segment 110 preferably includes a length of gearing surface 120 with a segment connector 130 at opposing sides as shown in FIGS. 3A-3G, 4A, and 4B.

A gearing segment 110 preferably includes at least one gearing surface 120. A gearing segment 110 could alternatively include two or more gearing surface as shown in FIGS. 3C and 3F. For example, a set of two sided gearing segments 110 (i.e., including two different surfaces) could be used in either making a spur gear with outer gearing or an ring gear with internal gearing.

A gear segment can additionally include a fixture structure 114 that functions to facilitate physical/mechanical coupling to a gear brace 140. The fixture structure 114 is preferably on a surface opposite that of the gearing surface 120. In one implementation, the fixture structure 114 includes a rigid structure with at least one defined through hole that facilitates bolting of a gear segment to a gear brace 140. The set of gearing segments 110 are preferably of uniform segment size. However, a variety of segment sizes may be used.

In a link variation, a gearing segment 110 can be a gearing link 116 that includes a rigid base structure 112 as shown in FIGS. 3A-3G. The set of gear segment no can be interconnected through segment connectors 130 that may be rotatable about a connector pivot point. Interconnected gear segments can be positioned and locked into a variety of different angular offsets to promote different gear system configurations. The angular offsets may be physically limited at the segment connectors 130 to prevent angles beyond maximum relative angle limits.

In a strip variation, a gearing segment 110 can include a flexible base structure as shown in FIGS. 4A and 4B. The flexible base structure could be a metal film or sheet, a rubber strip, a composite material, or any suitable structure. A flexible gearing segment strip 118 preferably snaps with itself or another gearing segment no at the segment connector 130. In an alternative variation, flexible gearing segment strip could alternatively be a length of strip, possibly provided as a roll of flexible gearing that can be cut or reduced to length. In a similar variation, a length of gearing segment strip 118 could be perforated so as to be subtractively customized to a particular length. In these reduction-usage variations, a single gearing segment no would be used, which could be customized in its length by measuring an appropriate length of gearing strip to use. Flexible gearing segment strips 118 may be used in combination with rigid gearing links 116.

### Gearing Surface

The gearing surface 120 of a gear segment 110 functions as the mechanism by which rotation and/or translation can be transferred to an engaged gear components. A gearing surface 120 can use physical gearing structures. Physical gearing structures can use parallel gearing or perpendicular gearing. Alternatively, magnetic gearing can be used where static magnetic regions or electromagnetically controlled regions can be arranged with alternating poles as shown in FIG. 3G.

A parallel gearing variation can include a gearing surface 120 with longitudinal structures (e.g., parallel grooves). A parallel gearing variation can be a rigid gearing link as shown in FIGS. 3A-C or a flexible gearing segment strip as shown in FIG. 4A. One potential benefit of a parallel gearing variation is that such a gearing surface can be resilient to a range of angles between interconnected gearing segments 110. The parallel gearing variation can be substantially similar to the parallel gearing variations described herein. For example, a gearing segment no with a parallel gearing surface 122 may include periodic protrusions. All or part of the periodic protrusions may be incorporated into the shape of the gearing segment 110. In one variation, a single periodic protrusion can be incorporated into one end of the gearing segment or in the middle as shown in FIGS. 3B and 3C. In another variation, two or more protrusions portions can be incorporated on either end as shown in FIG. 3A.

A system variation that includes a parallel gearing surface 122 may be used with additional parallel gearing components such as a pressure control mechanism to promote frictive contact and may be used for particular configurations such as the planetary frictional gear system that employ parallel gearing as described below.

In a perpendicular gearing variation, the gearing surface can include a perpendicular gearing surface 124 with gear teeth structures periodically repeated longitudinally. Helical gear teeth configurations could similarly be used as a variation of a more general non-parallel gearing variation. The perpendicular gearing variation is preferably used in combination with a flexible gearing segment strip. The profile of the gear teeth may be adjusted to account for an operable range of flexibility. A perpendicular gearing variation could alternatively use a rigid gearing link variation of a gearing segment no.

### Segment Connector

The segment connector 130 functions to interconnect at least two gearing segments no. The segment connector 130 can be any suitable type of fastener, structure, or mechanism to support fastening two gearing segments no. The segment connectors 130 can all be uniform. Alternatively, there may be complementary (e.g., male and female versions) segment connectors 130, which may promote a particular side alignment of two gearing segments no.

Preferably, a segment connector 130 can have at least three connection modes: a disconnected mode, a rotation connection mode, and a fixed connection mode. The segment connectors 130 can preferably be disconnected and reconnected in setting up a gearing configuration. The disconnected mode is when a segment connector 130 is not connected to another segment connector 130. The rotation connection mode preferably enables rotation or flexibility between two gearing segments no. A fixed connection mode preferably rigidly restrains the relative angle between two gearing segments no. Such different modes may not be used or may not be discrete.

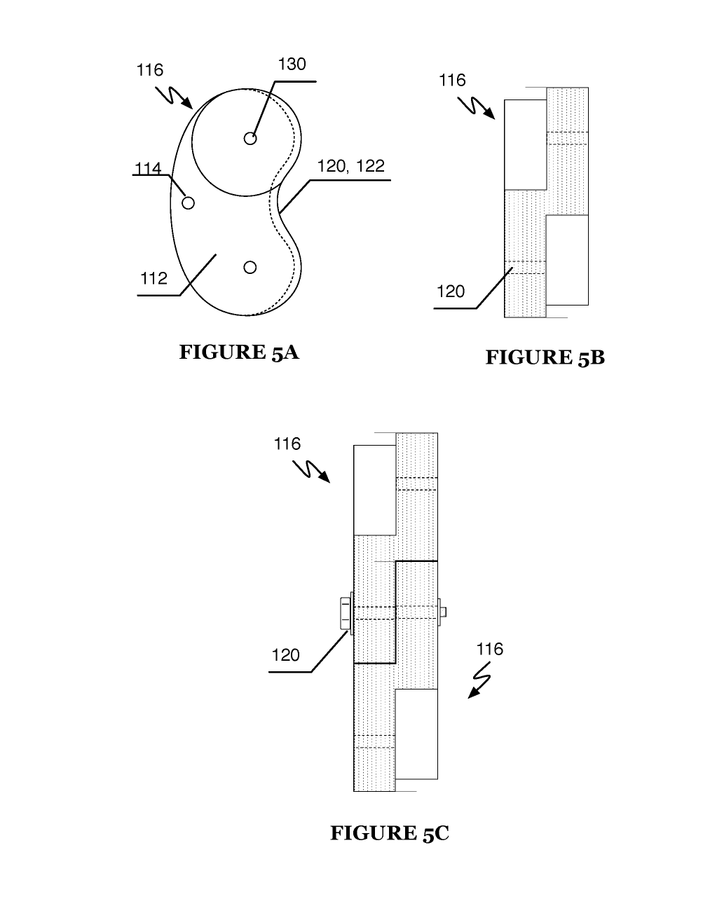

In some cases, the base structure is designed to accommodate intermeshing of two segment connectors. For example, defined indents may be provided in areas surrounding the segment connectors as shown in the side profile of a parallel gearing segment in FIGS. 5A and 5B.

In a flexible gearing segment strip variation, the gearing segment is substantially continuously flexible across the length of the strip—the segment connector 130 design when connected is preferably similarly flexible.

As another variation, the segment connector 130 can include rotation restraints to limit the range or rotation between two interconnected gearing segments. In a similar variation, the segment connector can include a set of periodically spaced stable states through indents or other mechanical features such that discrete angles can be snapped into place. Various other features may additionally be include to enable mechanical conveniences in aligning, positioning, and locking interconnected gearing segments no.

In one exemplary implementation, the segment connector 130 can be a physical structure feature of a gearing link where a defined through-hole cavity is included at either end of the length of the gearing link as shown in FIG. 5C. A bolt can be inserted to restrict motion to rotation, and the bolt can be tightened to rigidly fix the angle of two interconnected gearing links no. Similarly, pairs of interconnected gearing links could be stacked, and bolt could fix two or more layers of gearing interconnections.

### Gear Brace

The gear brace 140 functions to provide a rigid support to a set of interconnected gear segments 110 in a gearing configuration. The gear brace 140 preferably provides rigidity and can restrict the form of the gearing configuration during use of the gearing configuration. In some variations, the gear brace 140 can be optional, and the system may not use a gear brace 140. For example, the segment connector 130 may be sufficient in restricting relative motion between interconnected gearing segments 110 when in a fixe connection mode.

The gear brace 140 can be a multi-party component that can be fixed in place. The gear brace 140 may alternatively be a modular system that is build by a set of interconnected gear brace segments.

The design of a gear brace 140 may differ depending on the type of gearing configurations supported by the system. Gear braces 140 may go around, within, along the side, or physically couple with a set of gearing segments no in any suitable manner. An exemplary set of gear brace variations can include an outer circular gear brace 142, an inner circular gear brace 144, a linear gear brace 146, and/or any suitable type of gear brace 140.

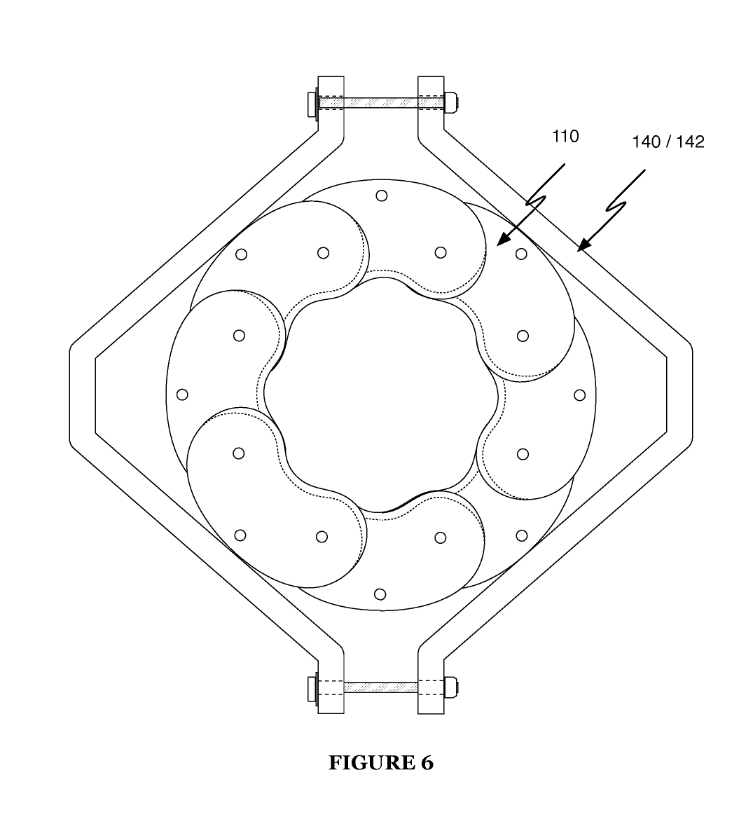

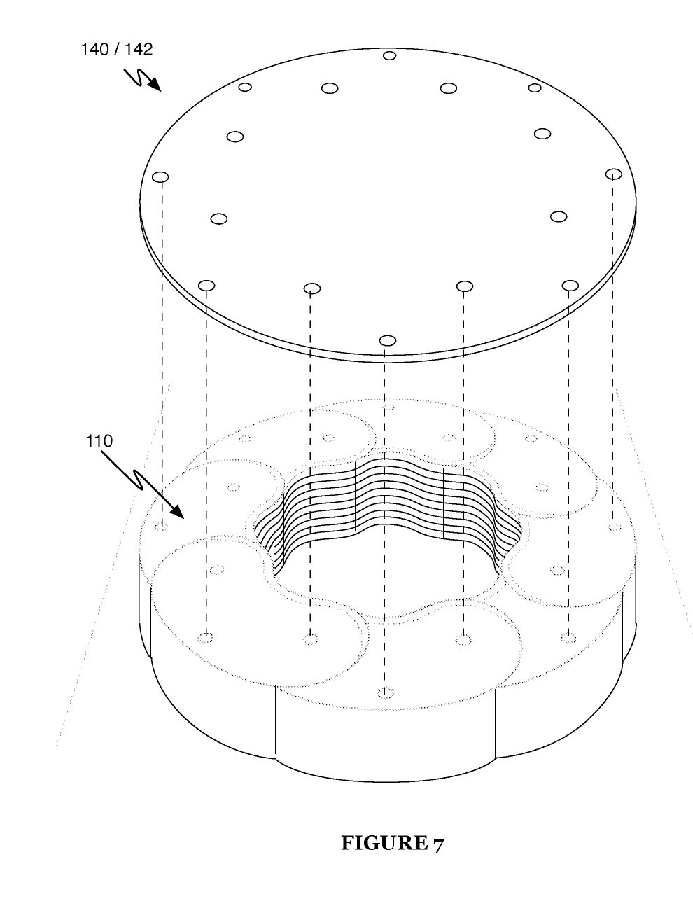

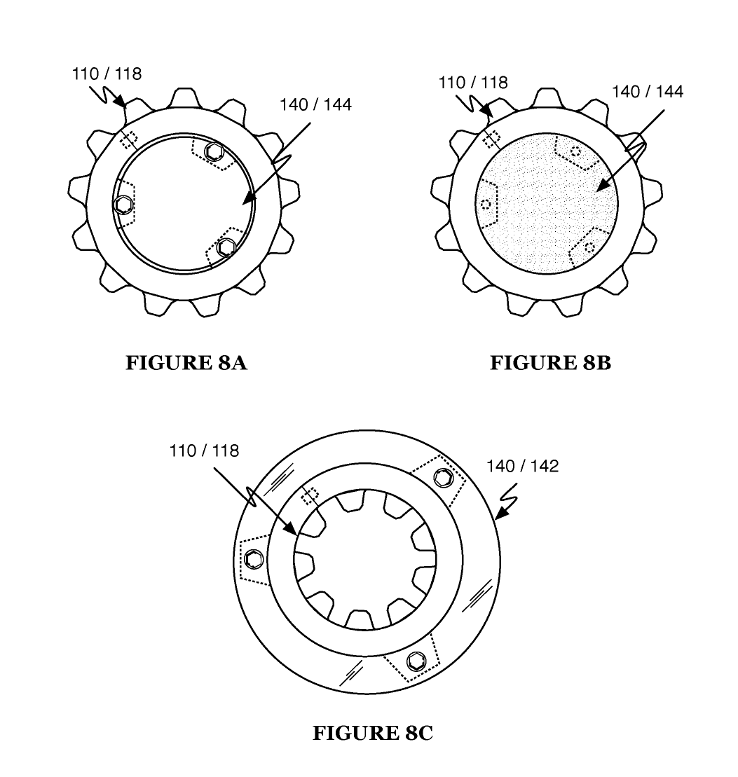

The outer circular gear brace 142 is preferably used with a gearing configuration that is an annular ring with an internal gearing surface. The outer circular gear brace 142 can substantially circumscribe the gearing configuration, preferably being able to be physically coupled to the set of gearing segments at multiple locations as shown in FIG. 6. The outer circular gear brace could supplement load bearing from outward forces. The outer circular gear brace 142 could alternatively be an outer plate attached to the gearing segments 110 along one or more faces of the gearing configuration as shown in FIG. 7 and FIG. 8C.

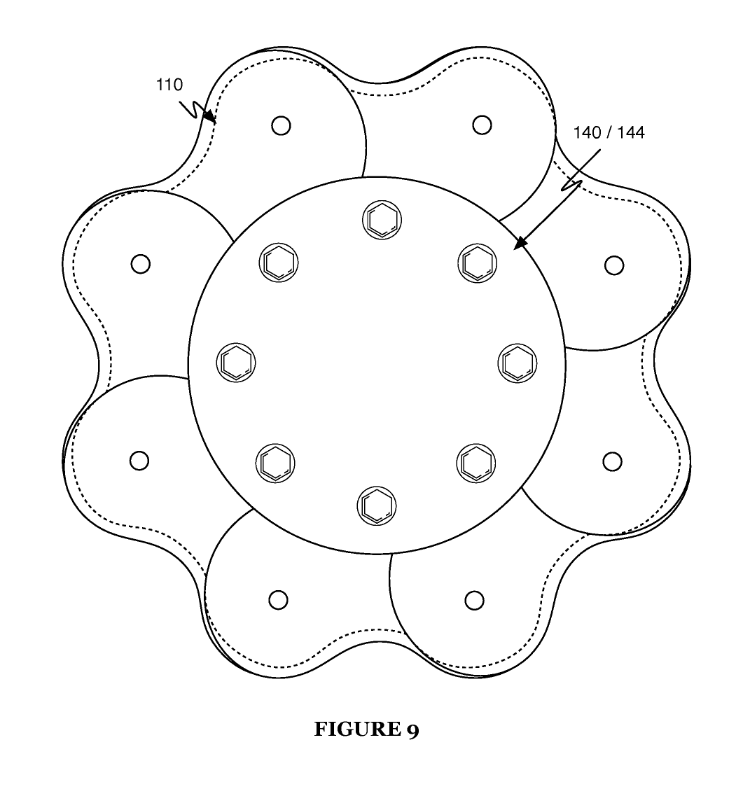

The inner circular gear brace 144 is preferably used with a gearing configuration that is circular (or alternative shaped gear) with an external gearing surface. The inner circular gear brace 144 can fit within a defined cavity of interconnected gear segments as shown in FIG. 8A and FIG. 9.

The outer circular gear brace 142 and the inner circular gear brace 144 can preferably adjust and/or accommodate different diameters. In one variation shown in FIG. 6, a two piece implementation can restrict motion for gears of various sizes. In another variation, the gear brace can be modular and increased or decreased in size appropriately. For example, modular brace segments could be designed with segment connectors like the gearing segments but may exclude a gearing surface.

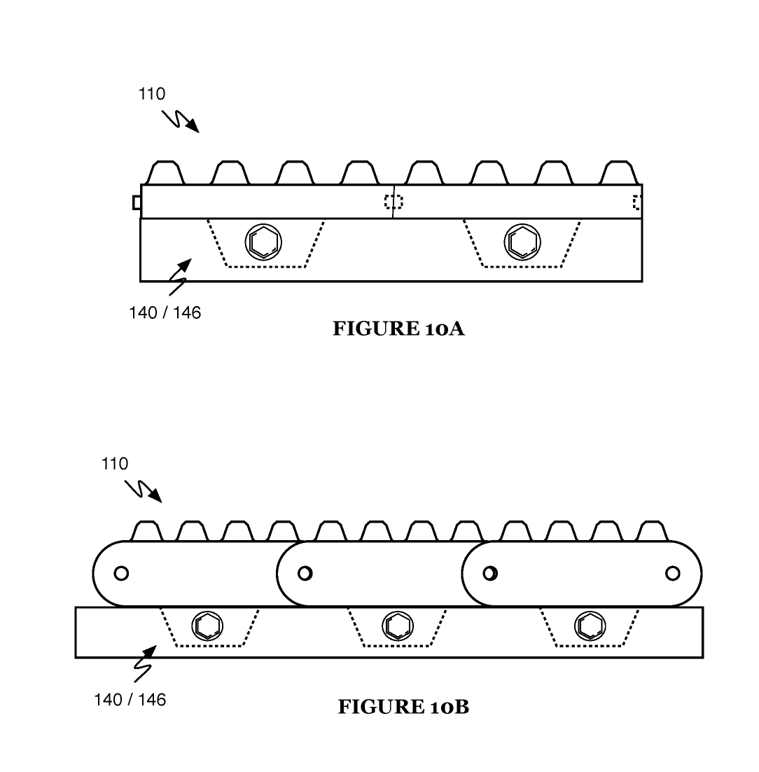

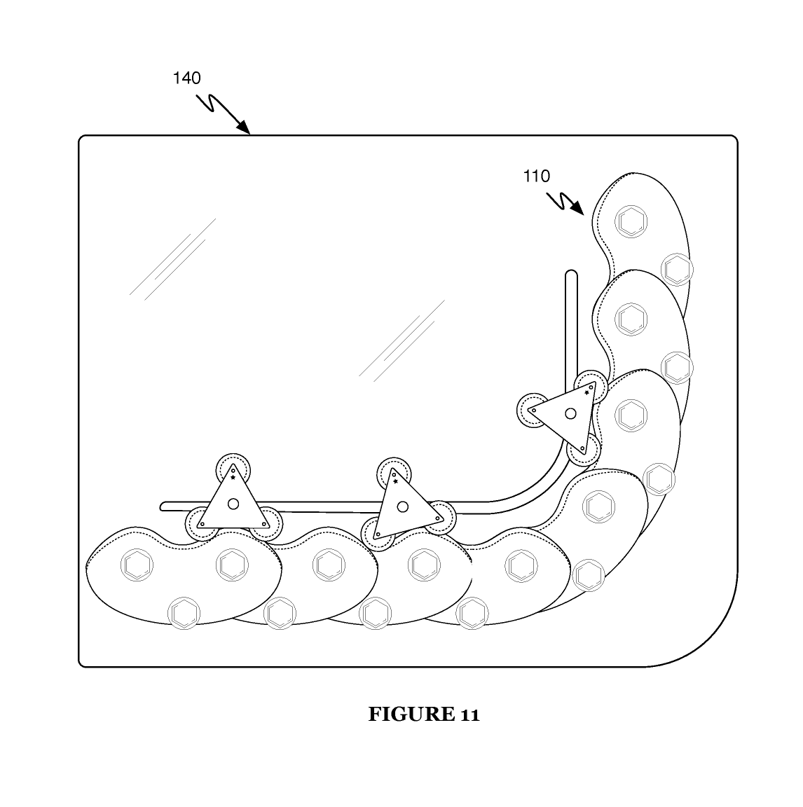

The linear gear brace 146 is preferably used for bracing different lengths of linear gear configurations as shown in FIGS. 10A and 10B. Alternative gear brace designs or systems can be used for arbitrary configured paths or forms. For example, a gear brace 146 can be a support structure for facilitating multiple aspects of a resulting gear system as shown in the exemplary a parallel gearing configuration of an arbitrary path of FIG. 11. Linear actuation of a planetary module can be guided through a rail mounted or integrated into the gear brace.

A gearing configuration is preferably reconfigurable such that the components can be disconnected and used in a different combination to create a different gearing configuration. The gearing brace no and the set of gearing segments can be disconnected and reused.

Alternatively though, the components of the system may be initially configured and then substantially permanently set in a gearing configuration. For example, an epoxy or material can be used as the gearing brace and used to set a gearing configuration. For example, an inner circular gear brace can be a composite material that is set within a defined cavity that substantially binds the interconnected gearing segments as shown in FIG. 8B. In an outer circular gear brace 142 implementation, an outer ring mold can be used in a similar fashion. This variation can use a simplified gear brace solution that does not need to be reversible and can easily be used with different configurations.

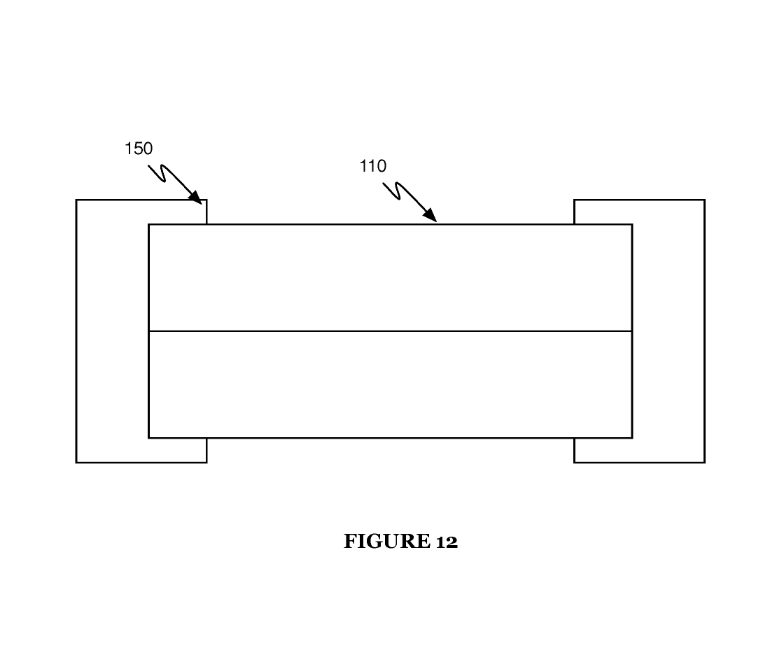

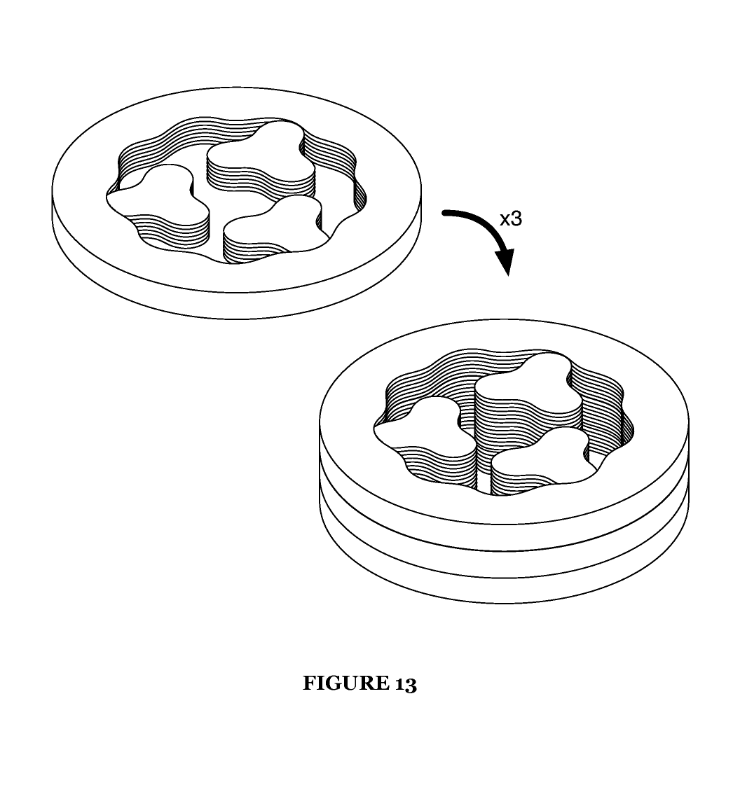

In one variation, the system can additionally include an inter-stack brace 150 as shown in FIG. 12. The inter-stack brace 150 functions to connect two or more gearing configurations side-by-side. This may be used in “stacking” the gearing configurations. In stacking, the two gearing configurations are substantially similar configurations, and they are coupled in a one-to-one arrangement. The two or more gearing configurations act as sub-configurations to form a stacked gearing configuration as shown in FIG. 13. The stacked gearing configuration can have customized width (e.g., customizable in gear segment width increments). Increased width may be used to support greater loads.

Additionally, two or more sub-gearing configurations may be interconnected in a staged gearing configuration when connected through an inter-stack brace, which is substantially similar to the stacked gearing configuration but internal gearing components may be coupled for non-one-to-one arrangement. This can be particularly useful where the gearing segments are used to form an annular ring configuration with an internal gearing surface. Internal gear components can be set to engage with the internal gearing surface, and those gear components can be coupled between different stages to alter the gear ratios.

As discussed the system can be used to create a variety of gearing configurations. Different implementations of the system can be used for different types of configurations. Some system implementations may support multiple gearing configuration types. The system can support circular configurations of different sizes and with internal or external gearing surfaces. Alternative shape configurations such as ellipses or arbitrary smooth shape forms could similarly be supported. The system can support linear configurations of different lengths. The system can additionally support non-linear, continuous paths.

### 2. A Parallel Gearing System

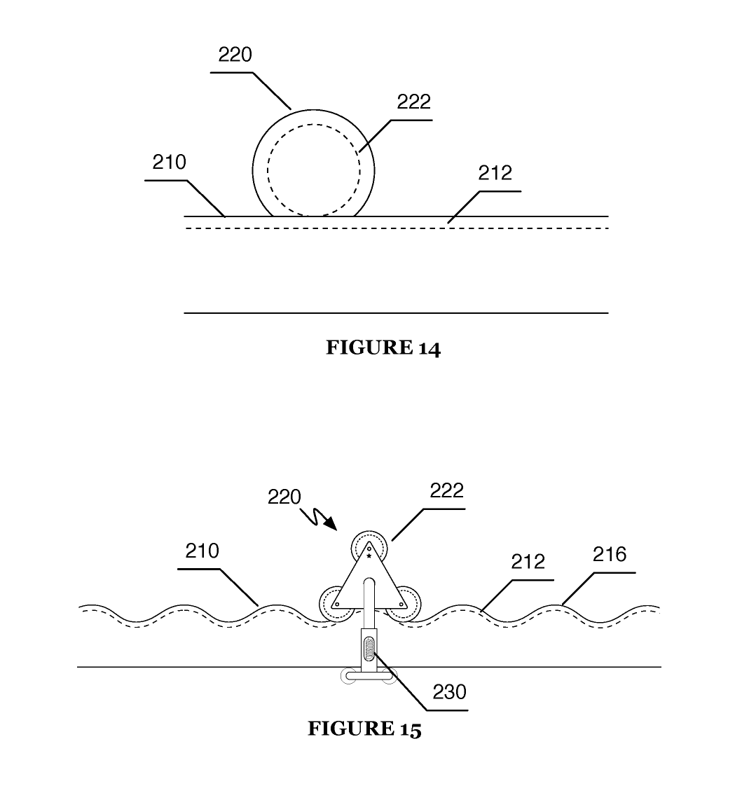

As shown in FIG. 14, a system for parallel gearing can include a first gear component 210 with a gearing surface 212 that includes a set of longitudinal structures 214 and at least a second gear component 220 with a gearing surface 222 with complementary longitudinal structures 224. A parallel gearing system preferably operates through frictive contact.

The parallel gearing system may additionally include periodic protrusions 216 along the first gear component 210 that complimentary work with a planetary module variation of the second gear component. The parallel gearing system may additionally include a pressure control mechanism 230.

A parallel gearing system can be used with the modular gearing system described above, but may alternatively be manufactured and produced as a non-modular system.

The first gear component 210 and second gear component 220 function as at least the two gear components that transmit rotation and/or translation through a parallel gearing interaction. As with non-parallel gearing systems, there may be a wide variety of configurations and arrangements of these two or more gear components.

Parallel gearing can be used for a variety of applications such as linear gear systems (e.g., rack and pinion configuration), arbitrary gear paths, external gears, internal gears, bevel gears, and other suitable arrangements. As described below, parallel gearing can be particularly applicable to a planetary frictional gear system that can be used as an alternative and potential improvement over harmonic drives, cycloidal gearing systems, and/or other gearing systems.

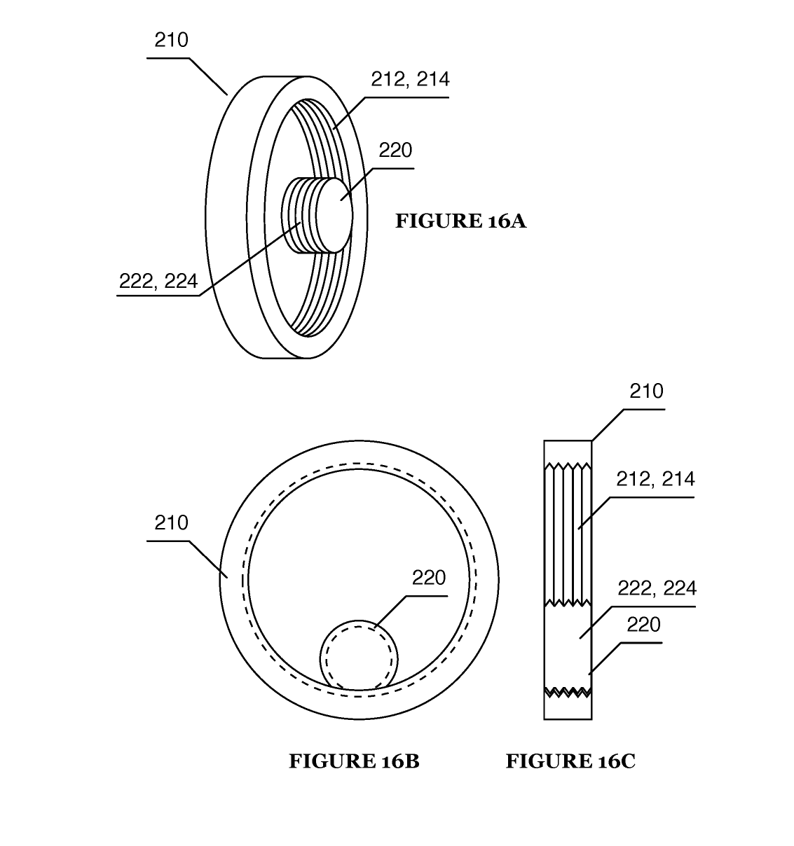

As shown in FIG. 15, in one configuration, a first gear component 210 can be a linear rail with a gearing surface 212 extending down its length. A set of longitudinal structures 214 (e.g., grooves) extend from one end to the other and preferably terminate at either end. The gearing surface can additionally include periodic protrusions 216 that are regularly repeat down the length of the first gear component 110. The second gear component 220 can be a circular gear as shown in FIG. 14 or a planetary module as shown in FIG. 15. Interaction between the first gear component 210 and the second gear component preferably create linear relative translation. Arbitrary continuous paths could similarly be created using similar principles as the linear configuration.

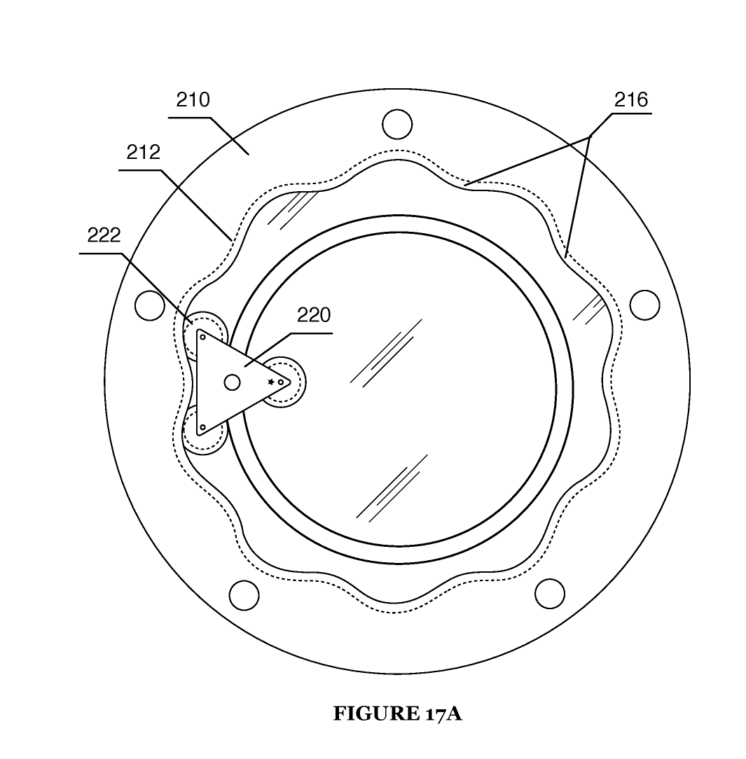

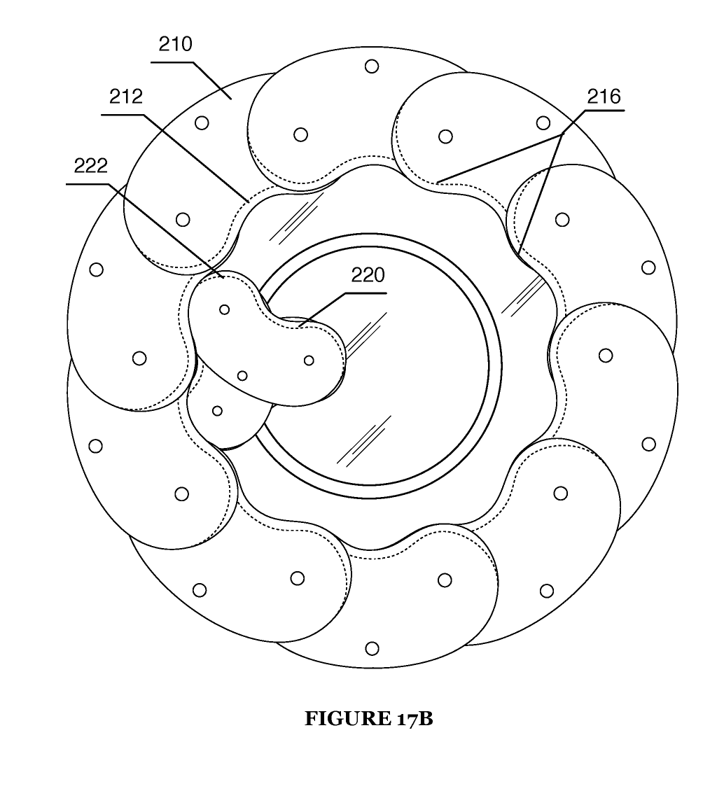

In one configuration of a contained gearing system, the first gear component 210 can be an annular ring with internal gearing surface 212, and the second gear component 220 can be a circular disk as shown in FIGS. 16A-16C, a cycloid-disk as shown in FIG. 13, a planetary module as shown in FIGS. 17A AND 17B, or another suitable component. Interaction between the first and second gear preferably creates relative rotation and/or circular translation. A contained gearing system can additionally be used in a multi planetary module system described below.

The first gear component 210 and second gear component could alternatively be circular gears with outer gearing surfaces. Preferably, a pressure control mechanism 230 can promote appropriate contact pressure.

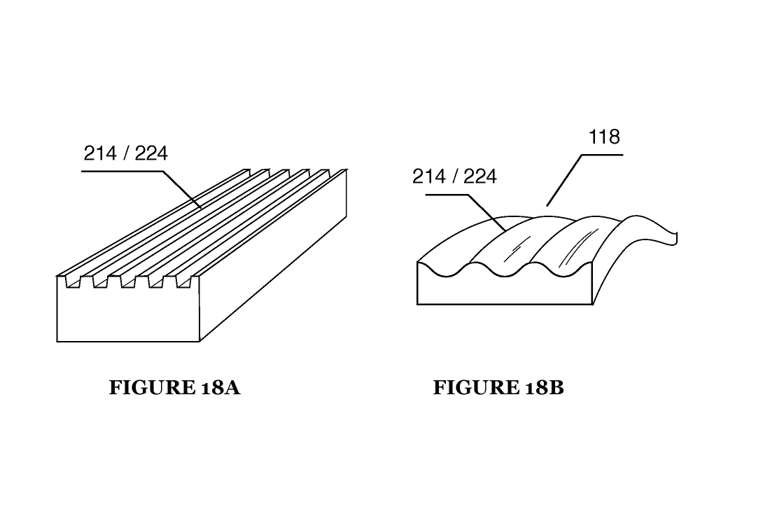

The gearing surface 212, which includes a set of longitudinal structures 214, and the gearing surface 222, which includes complementary longitudinal structures 224, functions to act as the gear teeth. In some respects the longitudinal structures 214 and 224 promotes increased friction and longer life of the gearing surface. Additionally, the longitudinal structures 214 and 224 can facilitate reduced backlash due to potentially a tighter fit and increased surface area contact. In other respects, the longitudinal structures 224 promote alignment. The pattern of the longitudinal structure is preferably a set of grooves (or conversely ridges, but herein grooves are used as the descriptor). The longitudinal structures 214 preferably extend along the length of a gearing surface as shown in FIG. 18A. Another potential benefit of the longitudinal structures and parallel gearing is that the gearing surface can be substantially continuous at connection points of gearing segments. Additionally parallel gearing can be integrated into flexible gearing segment strips without disrupting the gearing surface as shown in FIG. 18B.

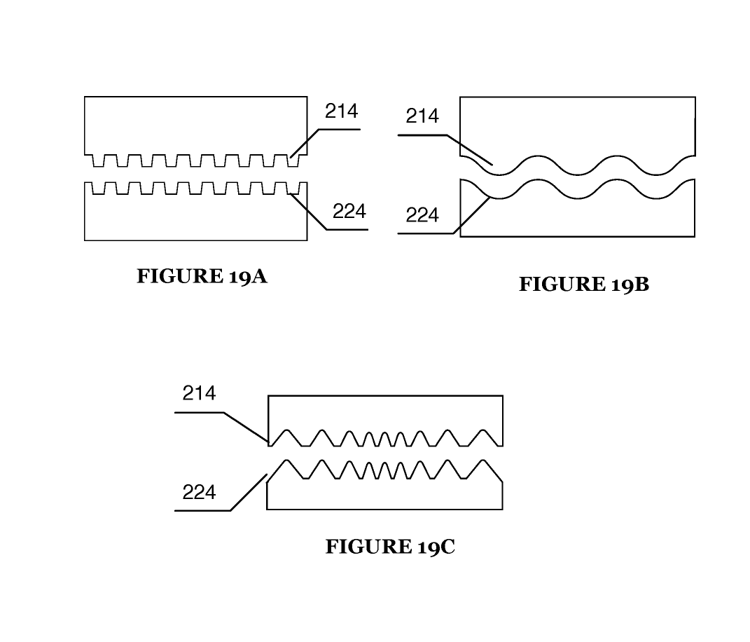

The grooves can have any suitable shape profile, such as a triangular pattern, a square pattern as shown in FIG. 19A, sinusoidal pattern as shown in FIG. 19B, involute-like tooth pattern, an irregular pattern, and/or any suitable pattern. The longitudinal structures 214 and 224 can have any suitable number of grooves and spacing. For example, a half inch wide gearing surface may have four parallel grooves extending longitudinally down the gearing surface, but any suitable sizing may be used. Additionally, the shape profile pattern can be variable as shown in FIG. 19C.

The gearing surface 212 preferably includes periodic protrusions 216 that interact with the second gear component 220. The periodic protrusions 216 function to provide a secondary physical coupling interaction. Preferably, the periodic protrusions prevent gross slippage between the two gear components 210 and 220. In a variation with periodic protrusions 216, the second component 220 is preferably a planetary module as shown in FIGS. 15, 17A, AND 17B. The planetary module will rotate about the periodic protrusions 216. As shown in FIG. 17B, the planetary module may be made of modular gearing segments as described above. In one variation, the periodic protrusions are continuous forms. In another variation, pegs may be used in place of solid protrusions.

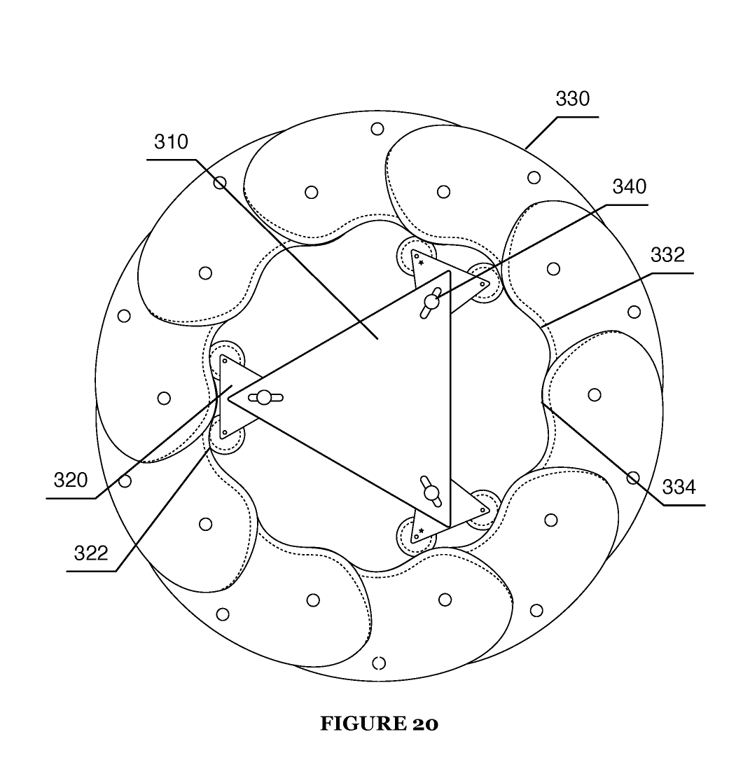

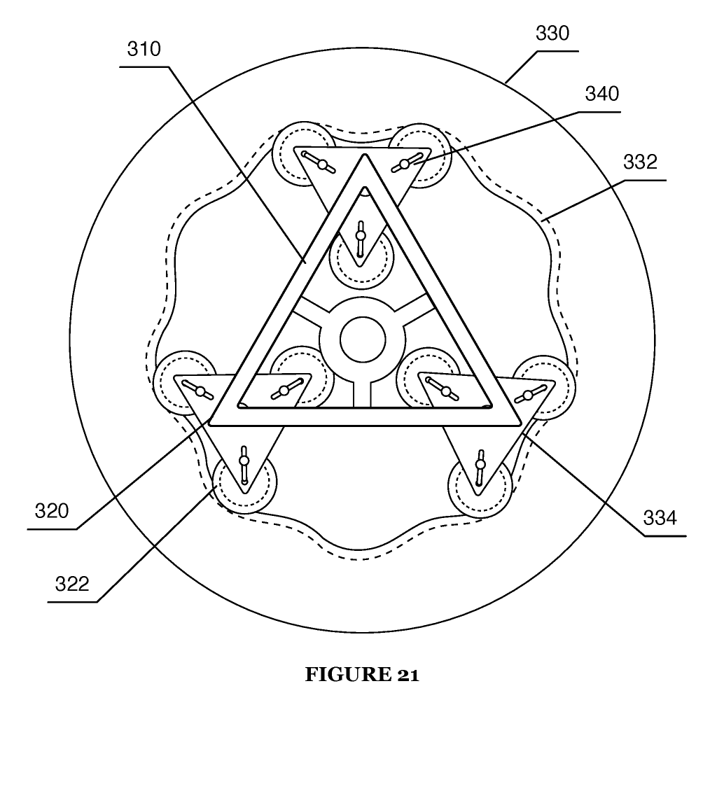

The pressure control mechanism 230 functions to apply an opposing force between the first gear component 210 and the second gear component 220. The pressure control mechanism 230 in one variation is a tunable setting such that a gear system could be “tuned” to proper settings. In another variation the pressure control mechanism 230 could be a spring or pressurized system that actively applies a force connecting the two gear components 210 and 220 as shown in FIG. 15. In yet another variation, the pressure control mechanism 230 could be dynamically controlled so that the applied force could be dynamically adjusted, which could alter interactions between the two gear components 210 and 220. In a multi-planetary module system as shown in FIG. 20, multiple units of pressure control mechanisms 230 can be used for each planetary module or sub-module as shown in FIGS. 20 and 21. In some variations, no pressure control mechanism 230 is required as natural usage or gravity can provide the desired forces.

### 3. Planetary Frictional Gear System

One particular parallel gearing system is a planetary frictional gear system. The planetary frictional gear system described herein can be used in combination with the modular gearing system described herein, but may alternatively be implemented without a modular design.

As shown in FIGS. 20 and 21, a planetary frictional gear system of a preferred embodiment includes a central core 310 coupled to a set of planetary modules 320 with parallel gearing surface perimeters 322, and an annular ring 330 with parallel gearing surface 332 on an internal perimeter surface and a set of annular protrusion 334. The system functions to provide an economical, high-performance gearing system. The system can act as an alternative to harmonic drives, cycloidal gearing systems, and/or other gearing systems.

The system in one preferred implementation can be used as a planetary gearing system. As a planetary gearing system, an instance of the system could be used in a multi-stage system. Additionally, multiple instances with different configurations can be used in combination with a multi-stage system. As discussed above, the planetary frictional gear system can be stacked for rigidity or staged in a stacked configuration for alternative gear transmissions.

As another potential benefit compared to a cycloidal system, the system can be backdrivable. For example, when applied to the field of robotics, the system can be backdriven and physically manipulated during a motion training process. Additionally, the system can lack the eccentric properties of a cycloidal system, and thus may avoid vibrational effects.

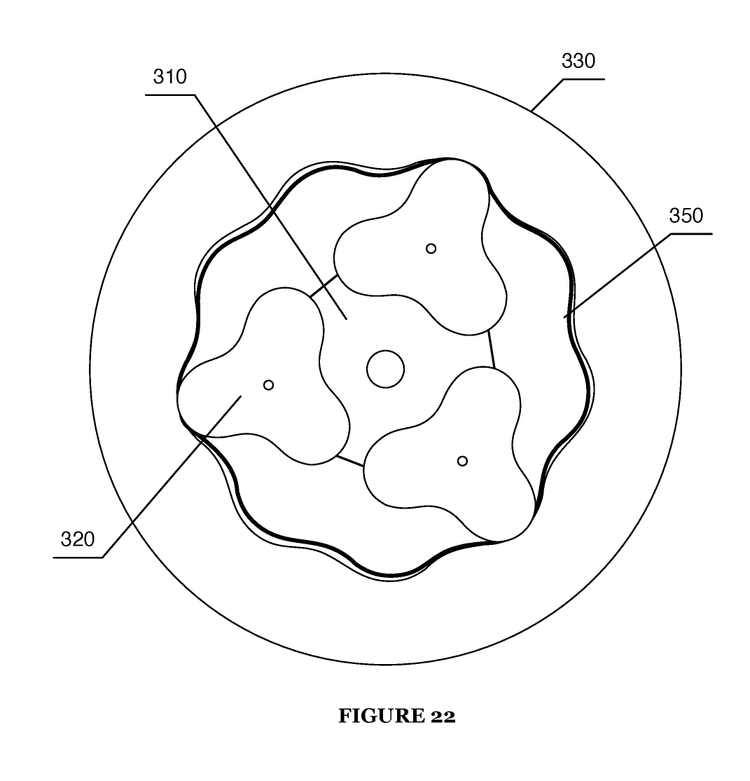

As shown in FIG. 22 an alternative embodiment of the system can include a flex spline 350 with an outer perimeter less than the internal perimeter of the annular ring 330, which functions to operate the system as an alternative to a strain wave gear and more specifically a harmonic drive. The flex spline embodiment of the system can provide high gear ratios, which, as an example, may range up to 30:1 or even 350:1. Input and outs of the flex spline embodiment of the system can additionally be coaxial.

As compared to a strain wave gear, the system may be more efficiently manufactured at a lower cost. The parallel gearing is frictional based, and may be manufactured using a horizontal lathe without the customized fitting of pieces common in the manufacturing of a strain wave gear.

### Central Core

The central core 310 functions as sun gear equivalent component of the system. The central core 310 is preferably a centrally located gearing component contained within the system. The central core 310 can have a centrally positioned shaft. The shaft of the central core 310 can be used to drive the system but may alternatively be used as an output. In some variations, the central core may be held stationary.

Within the system, the central core 310 functions as the mechanical coupling between a shaft in the center axis and the planetary modules 320. The central core 310 is preferably physically coupled to a set of planetary modules at a set of coupling points. The coupling points are preferably symmetrically distributed at a fixed distance about the center of the central core 310. The coupling points may alternatively be positioned to have an asymmetrical layout. The coupling point distance is preferably sufficient to enable the planetary modules 320 to engage with the internal perimeter of the annular ring 310 and to allow the planetary modules to rotate without restrictive contact with the other planetary modules 320.

The central core 310 preferably engages with the planetary modules 320 through a rotation axel that enables the planetary modules to rotate about the coupling point. Alternatively, the central core 310 can physically couple with a planetary module through a gearing interface which is preferably a perpendicular gearing interface but could alternatively be a parallel gearing interface.

The central core 310 can be a structural component. The central core 310 could be a solid structure that extends out to the axes of the planetary modules 320. The solid structure could be a disc, a polygon (e.g., with each point corresponding to an axis of a planetary module 320), or any suitable shape. The planetary modules may rotate about the coupling point. Alternatively, the central core 310 could be a central sun gear or other mechanical system that interacts with the planetary modules 320 through a geared or frictional interaction. In one variation, the central core 310 could use a tooth gear.

### Planetary Modules

The set of planetary modules 320 functions as planetary units that rotate about the central core 310. There can be any suitable number of planetary modules 320. The set of planetary modules are preferably symmetrically positioned about the central core 310, which functions to provide balanced engagement with the annular ring 330. In one implementation, there are three planetary modules evenly distributed about the center of the system. Alternatively, the set of planetary modules may not be balanced. For example, there may be a single planetary module 320 in the set. In another example, in a set of three planetary modules 320, a first planetary module 320 could be at ninety degrees from a second and third planetary module 320, and the second and third planetary modules 320 could be one hundred and eighty degrees apart. The planetary modules 320 are preferably substantially identical in component design and configuration. Preferably, the planetary modules 320 are phase synced such that each planetary module engages with the annular ring 330 in a matching state. For example, a single sub-planet engages with the annular ring in between two protrusions at the same time across multiple planetary modules 320. Alternatively, the planetary modules 320 may be phase shifted such that at least two of the planetary modules engage with the annular ring 330 in offset states. For example, a sub-planet of a first planetary module 320 can engage with the annular ring in between two protrusions at the same time two sub-planets of a second planetary module 320 engage with a protrusion on either side.

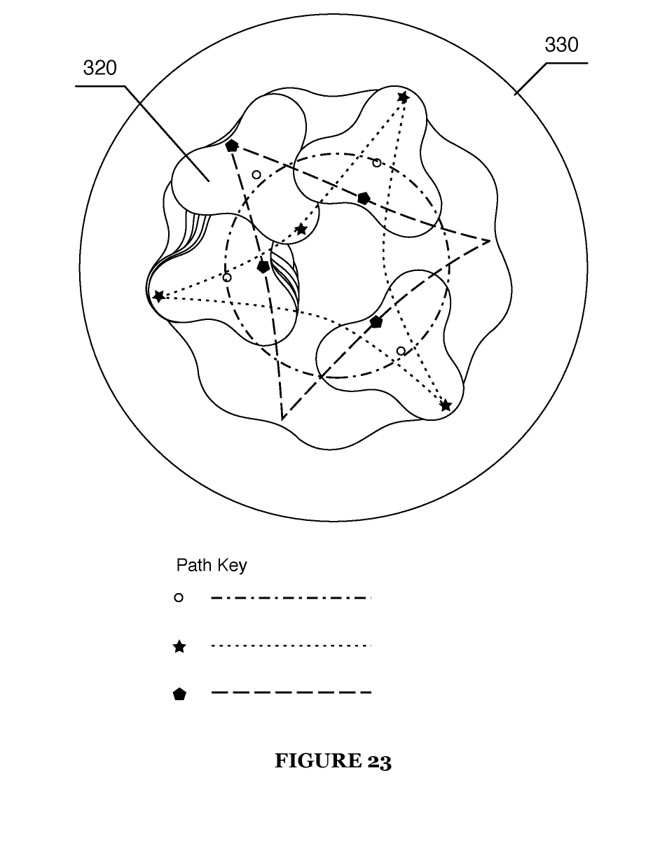

A planetary module 320 can have a variety of designs. The overall profile of the planetary module 320 is preferably configured to steadily engage with set of annular protrusions 334 during a circular rotation along the internal perimeter of the annular ring 330. In other words as the planetary module 320 rotates in a circular path concentric with the annular ring, the profile of the planetary module 320 is such that the annular protrusions 334 provide substantially constant contact without preventing rotation, and the annular protrusions 334 do not cause oscillation of the center point of the planetary module 320. As shown in FIG. 23, the planetary module follows a regular hypocloidal path during activation.

The planetary module 320 preferably includes multiple sub-planet components 324. In one preferred implementation, each of the sub-planet components is an independent circular gear that is physically coupled about a common coupling point as shown in FIGS. 20 and 21. The circular gears of the planetary module 320 rotate independently. The circular gears of the planetary module sequentially engage with the annular ring 330 with preferably one or two circular gears being physically coupled at any one time. In one implementation, a planetary module 320 has a planetary chassis that is coupled with the central core 310 at a coupling point and three circular gears that are axially coupled to the planetary chassis at three points symmetrically positioned about the coupling point.

Alternatively, the planetary module 320 can be a solid gearing piece wherein the sub-planet components 324 are structure features (i.e., protrusions) as shown in FIGS. 13 and 22. The shape profile of the solid planetary module 320 can be a regular undulating profile that includes an alternating sequence of convex protrusions. The convex protrusions preferably have a circular curve profile but may alternatively have any suitable shape profile that corresponds with the profile of the annular ring 330. While the planetary module 320 is preferably composed of either a single unit or a set of independent sub-planetary gears, alternative implementations may use a combination of some protrusions being a unified unit while a subset of the protrusions being independent gears.

A planetary module 320 engages with the annular ring along the perimeter surface of the planetary module 320. The perimeter surface is preferably defined as the surface along the sides of the planetary module. In other words, the perimeter surface is the surface(s) tracing the path of the shape profile and opposing the base surface of the planetary module 320.

The perimeter surface is preferably a parallel gearing surface 322 as described above. Parallel gearing surfaces preferably acts as a frictional contract feature that promotes relative translation and/or rotation between a planetary module 320 and the annular ring 330. The parallel gearing surface includes longitudinal structures or grooves that extend around the perimeter of the planetary module 320.

The parallel gearing surface 322 preferably physically couples with the parallel gearing surface 332 of the annular ring 330. In the independent gear variation, each gear can have parallel gearing 322. In the single unit planetary module 320, the parallel gearing can trace around the perimeter surface. The parallel gearing is preferably located where contact will be made, but areas that will not make contact may not have the parallel gearing 322. For example, a single unit planetary module 320 may have a form where the parallel gearing surface is not continuous around the entire perimeter because of interactions with the protrusions 334.

### Annular Ring

The annular ring 330 is the outer ring that circumscribes and/or contains the other components. The annular ring 330 defines an internal cavity such that the annular ring 330 has an internal surface. The planetary modules 320 preferably physically couples and interacts with the annular ring 330 at the internal surface. The internal perimeter surface of the annular ring 330 preferably includes complementary gearing to the gearing used in the planetary module 320. Preferably, the gearing is a parallel gearing surface 332 that follows the internal perimeter surface of the annular ring 330.

The annular ring 330 additionally includes a set of annular protrusions 334, which function as structural features. The annular protrusions 334 preferably form a macro cycloidal gear profile, where the cycloidal “tooth” profile is based on the size of the sub-planet components 324 of the planetary module 320. The annular protrusions 334 can mitigate the occurrence of backlash. A planetary module 330 will rotate about the annular protrusions 334, and potential slippage at the parallel gearing surface may be counteracted by the physical coupling of the planetary module with the annular protrusions 334. The primary mechanical coupling occurs at the gearing surface of the annular ring 330 and the planetary modules 320, but the annular protrusions 334 can act as a secondary mechanical coupling that can prevent gross gear “slippage”. The annular protrusions 334 are preferably structural elements that extend out from the body of the annular ring (i.e., inwards toward the defined center point of the annular ring 330). Alternatively, pegs or other forms may be used to achieve similar mechanical interactions between the annular ring and the planetary modules 320. The annular protrusions 334 are preferably regularly spaced defined around a defined circle. The depth, curve profile, spacing, and other physical characteristics are preferably configured such that functional contact can be established with the planetary modules 320 during operation. a sinusoidal undulating profile may be used.

As shown in FIG. 20, a system for modular gearing can be used in creating the annular ring 330. The gearing segments can include a number of protrusions 334 such that when interconnected into a gearing configuration, the annular ring configuration includes a periodic set of protrusions.

The assembly of the system preferably sets the planetary modules 320 at a displacement from the internal perimeter of the annular ring 330 such that a satisfactory level of surface pressure is established. In one variation, the planetary modules 320 are statically set. However, the system may include a pressure control mechanism 340, which can function to make the fitting of the planetary modules 320 adjustable.

The pressure control mechanism 340 in one instance may allow the torque properties of the system to be adjusted by adjusting the surface pressure between the parallel gearing of the annular ring 330 and the planetary modules 320. For example, the planetary modules may be set to more tightly press against the internal perimeter of the annular ring 330 for higher torque applications.

### Pressure Control Mechanism

The pressure control mechanism 340 in another instance may function to enable maintenance to be applied to the system after components have worn down. As opposed to other systems where the wearing of teeth cannot be easily remedied, the use of parallel gearing enables the pressure to recalibrate to restore the system to desired operating parameters.

In one variation, the pressure control mechanism 340 includes a planetary module adjustment system as shown in FIG. 21. The planetary module adjustment system can enable the positioning of the sub-planet gears or features to be modified to promote greater or less pressure. The adjustment system could use a gearing system, a spring system, and/or any suitable type of mechanism. The various sub-planet gears are preferably uniformly adjusted through the adjustment system. In an alternative implementation, each of the sub-planet gears or features may be individually adjusted and tuned.

In one variation, the pressure control mechanism 340 includes a central core adjustment system which functions to vary the coupling point between a planetary module 320 and the central core 310. For example, the mounting point of the planetary module to the central core 310 could be variable. In one variation, the coupling point could be adjusted along a line defined that radially extends from the center of the central core 310 as shown in FIG. 21. In another variation, there could be a set of discrete mounting points, where a planetary module could be repositioned. Each planetary module 320 could be individually adjusted, but a centralized mechanism could enable single point manipulation of the set of planetary modules.

The pressure control mechanism 340 could be a maintenance or configuration feature, but in some variations, the pressure control mechanism 340 could be dynamically controlled. A dynamic pressure control mechanism 340 could be used to change the pressure to operate the system in different modes. For example, a system could normally operate with a default torque performance property, but during particular times when high amounts of torque are desired, the pressure control mechanism 340 could switch the system to a high torque mode by increasing the surface pressure. In some implementations, this can function to enable a pressure control mechanism 340 to transition a system from operating in high and low torque modes, where a low torque mode may have less wear on the system, thereby can extend the life of the system.

The pressure control mechanism 340 or an alternative element of the system could additionally measure the pressure setting of the system such that the state of system could be observed. The pressure sensing could additionally be used in combination with observing usage of the system to an effective lifetime estimation based on the amount of usage and the pressure settings during usage. The pressure control mechanism 340 could include integrated sensors and control system such that the settings of the pressure control mechanism 340 can be monitored and controlled by an external system.

The system could be used as an alternative planetary gearing system. Various gear ratios may be achieved depending which components are used as the output, input, and held stationary.

### Flexspline

In an alternative embodiment shown in FIG. 22, the system could include a flex spline 350, which functions to emulate the gearing ratio capabilities of a strain wave gear.

In the flex spline embodiment, the set of planetary modules 320 and the annular ring 330 do not physically engage directly. Instead, the planetary modules 320 engage with the annular ring 330 with the flex spline 350 as an intermediary element.

The flex spline 350 includes a flexible portion that circumscribes the set of planetary modules 320 and the central core 310. In one implementation, the flex spline 350 can include a defined concave cavity like a cup. The base of the flex spline 350 can be a rigid structure. The base could be attached to a shaft or mechanically coupled to some other component. The walls defining the concave cavity are preferably flexible and can be deformed. The thin walls of the flex spline 350 are the portions that are used in the physical interaction of the system. The length of the flex spline 350 is preferably less than the length of the internal perimeter of the annular ring 330 as shown in FIG. 22. The length difference can be set to provide the appropriate gear ratio. The flex spline will exhibit slow rotation when driving the central core 310. The flex spline 350 can be configured to flex to accommodate the annular protrusions of the internal perimeter.

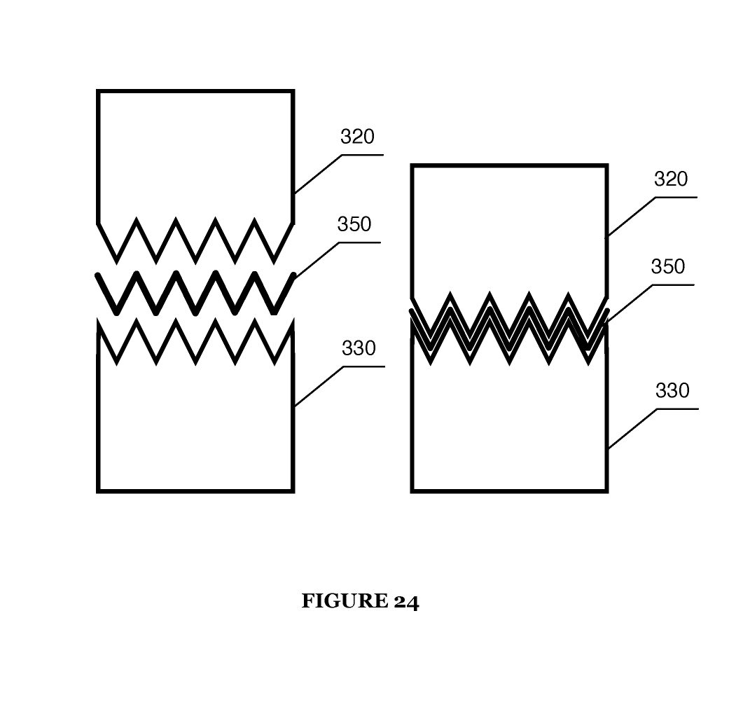

The flex spline 350 in one variation includes a parallel gearing surface pattern such that when fully engaged, a planetary module 320, the flex spline 350 and the annular ring 330 have mating profiles as shown in FIG. 24. Other structural forms may alternatively be used by the flex spline 350.

The components of the system can be made of any suitable material. The parallel gearing can be machined using a horizontal lathe, but the parallel gearing and other components may be made through any suitable manufacturing technique.

The components of the system can similarly be designed and implemented at a variety of scales. The system can be customized to satisfy a wide variety of torque performance properties and support different gear ratios.

An inter-stack brace may be used in connecting multiple planetary frictional gear systems, which as described, can be for mechanical properties or for staging and changing gear ratios. Instances of the system can be used in multiple stage gearing solutions. A set of planetary gear system variations, a set of flex spline system variations, and/or any suitable gear system may be used in combination. In one exemplary implementation, a planetary gear system variation with a five to one gear ratio could be combined with a flex spline system variation with a gear ratio of two hundred to one. The resulting gearing ratio would be one thousand to one.

As a person skilled in the art will recognize from the previous detailed description and from the figures and claims, modifications and changes can be made to the embodiments of the invention without departing from the scope of this invention as defined in the following claims.

We claim:

1. A configurable gear system comprising:
a set of gear segments;
each gear segment of the set of gear segments comprising:
a base structure,
a gearing surface connected to the base structure and extended along at least one face, and
two segment connectors at opposing sides of the gearing surface; and
wherein at least a subset of the gear segments interconnect through the gear connector interface into a gearing configuration.

2. The configurable gear system of claim 1, further comprising:
a first count of gear segments selected from the set of gear segments interconnect through the gear connector interfaces in a first gearing configuration; and
a second count of gear segments selected from the set of gear segments interconnect through the gear connector interface in a second gearing configuration that is distinct from the first gearing configuration.

3. The configurable gear system of claim 1, further comprising a gear brace that physically couples to the gear segments in the gearing configuration on a face of the gear segment that is not the gearing surface.

4. The configurable gear system of claim 1, wherein the gear segment is a rigid gear segment link.

5. The configurable gear system of claim 1, wherein the gear segment is a flexible gearing segment strip.

6. The configurable gear system of claim 1, wherein the gearing configuration is an annular ring configuration with an internal gearing surface.

7. The configurable gear system of claim 1, wherein the gearing configuration is a circular ring configuration with an external gearing surface.

8. The configurable gear system of claim 1, wherein the gearing configuration is a linear gear configuration.

9. The configurable gear system of claim 1, wherein the gearing configuration is a non-linear, continuous path gearing surface.

10. The configurable gear system of claim 1, wherein the gearing surface is a parallel gearing surface that comprises a longitudinal gearing structure.

11. The configurable gear system of claim 10, wherein the parallel gearing surface further comprises at least one protrusion; wherein the subset of gearing segments in the gearing configuration form a connected gearing; and the connected gearing surface comprising periodic protrusions formed by the at least one protrusion of the gearing segments.

12. The configurable gear system of claim ii, further comprising a planetary module with a parallel gearing surface that complimentary engages with the connected gearing surface.

13. The configurable gear system of claim 12, further comprising a pressure control mechanism that modifies the contact force between the connected gearing surface and the planetary module.

14. The configurable gear system of claim 12, wherein the gearing configuration is an annular ring configuration with an internal gearing surface; wherein the planetary module is part of a set of planetary modules; and further comprising a central core positioned within a defined cavity of the annular ring configuration, the central core being coupled to the set of planetary modules.

15. The configurable gear system of claim 14, further comprising a flexspline circumscribing the set of planetary modules and positioned in between the connected gearing surface and parallel gearing surfaces of the planetary modules.

16. The configurable gear system of claim 14, further comprising an inter-stack brace that physically couples the gearing configuration to a second gearing configuration.

17. The configurable gear system of claim 1, wherein the gearing surface is a non-parallel gearing surface that comprises a set of gear teeth that extend across the width of the gearing surface.

18. The configurable gear system of claim 17, wherein the gear segment is a flexible gearing segment strip.

19. The configurable gear system of claim 1, wherein the gearing surface is a magnetic gearing surface.

20. The configurable gear system of claim 1, comprising an inter-stack brace that physically couples the gearing configuration to a second gearing configuration.
